(19) United States
(12) Patent Application Publication
(10) Pub. No.: US 2008/0098966 A1
(43) Pub. Date: May 1, 2008

(54) Passive chemical irritant release system for personal and pet defense

(76) Inventor: John Knoblach, (US)

Correspondence Address: John Knoblach, 60 Old Farm Hill Rd, Auburn, ME, 04210, US

(21) Appl. No.: 11/554,021

(22) Filed: Oct. 28, 2006

(51) Int. Cl. A01K 27/00

(52) U.S. Cl. 119/855

(57) ABSTRACT

A dormant pressurized or non-pressurized pouch, canister or bag containing a debilitating substance, such as a pepper mace, that deploys when bitten, clawed or otherwise punctured or squeezed. Attached or imbedded on a pet's collar, on a hiker's clothing or on a rancher's animal, the victim does not need to activate any defensive measure when attacked; the attack itself releases the chemicals. The chemical defense system not only curtails any immediate attack due to instant disbursement of debilitating chemical agents, but also allows some protection over time as the victim is temporarily coated with noxious chemicals, and able to escape the attack.

### SPECIFICATIONS AND BACKGROUND OF THE INVENTION

The present invention relates to methods of self-defense for humans or pets, specifically when during an attack any pressure from a bite, clawing, impact or puncture will cause the bladder bag/canister to explode and release debilitating pepper spray. This causes the attacker to be subjected to this chemical deterrent due to the attacker's own actions. This also allows or causes the wearer to be temporarily covered in the noxious debilitating pepper spray thus making them less likely to be re-attacked.

There are any many self-defense-related articles known in the industry. Many U.S. Patents disclose a deterrent release system that is active; meaning the victim must initiate the defensive maneuver with the sprayer, or in some way deliver the spray on to the attacker. The repellant canister then dispenses some chemical aerosol to stop an attacker.

Another example of a pepper spray discharging system that is more passive than most is U.S. Pat. No. 6,634,523. This combines a hand glove and aerosol repellant device, but still requires the victim to “punch” the attacker thus releasing the agent. Another example of a more lethal system is found in U.S. Pat. No. 4,338,886. That system describes an animal collar that has within its embodiment two static pouches that are filled with deadly chemicals, which are disbursed when bitten or eaten. That lethality and static design of pouches on expandable collars is the limiting factor for that patent, and makes it very different from this current design. In this design, a pre-manufactured non-lethal pressurized pouch and holder can be attached to any article of clothing (or a collar). Also, the toxicity and lethality of U.S. Pat. No. 4,338,886 causes legal issues that limit its use, and can be outlawed in some areas. Also, using deadly toxic collars (U.S. Pat. No. 4,338,886) against certain predators or in areas with those predators is illegal.

All current manners, excepting the one example just mentioned, to actively utilize an aerosol to dispense a substance, such as pepper spray or mace to disable a would-be attacker all involve some level of action by the victim. Either actively removing a spray can from a pouch or necklace, or exploding a pouch while punching the attacker. For these systems to work, the victim must be both coherent as well as knowledgeable on how to activate the deterrent chemical. This is a major shortcoming of using these defensive systems for non-coherent people or any animals needing protection.

Common self-defense chemical irritant deployment systems also generally release all chemicals at the attacker. For many situations, including animal attacks, the missing of the target provides minimal protection and deterrent effect. Also, an animal attacker, temporarily blinded by a chemical deterrent can still continue an attack. An animal that is very hungry often times would continue an attack regardless of if it had mace in its eyes.

Therefore, it would be advantageous to develop a self-defense system that would apply a debilitating substance using a passive, attacker-activated delivery system. This reactive defensive posture works with both a pressurized method of delivery, as well as dormant non-pressurized bag. Such a system would allow for close range deployment with the additional benefit of cross-contamination, meaning the victim is now somewhat coated with the noxious material, and less palatable to a would-be attacking animal. This invention is unique in that it allows humans with minimal skills to have a certain level of protection against attack. This invention also applies to pets that can be protected from attack by larger predators. Such a device can also be used in many other applications including protecting doors that bears have been known to break open. Livestock can also be protected this way, and can minimize or completely stop attacks by wolves, bears, lions and other mammals.

### SUMARY OF THE INVENTION

One aspect of the present invention is a self-defense element whereby after the puncture of the bladder bag, an attacker (human or animal) would be subjected to a chemical irritant such as Oleoresin Capsicum (HOT CAYENNE PEPPERS). This has the ability to temporarily disable the attacker and provide for the victim's escape. This is the key benefit from this device; allowing a victim a moment to escape.

Another aspect of the present invention is a specific deterrent of further attacks by an animal because the victim now also has a covering of this chemical irritant. This causes the same reaction that a predator would have when attacking a skunk. The attacking animal upon re-attacking the victim would encounter the same noxious chemical reaction and would leave to seek out a better smelling/tasting victim. This has tremendous potential to save small pets in locations where lion attacks and bear attacks result in the loss of domestic pets. A predator that experiences such noxious chemical reactions when attacking a neighborhood pet may be imprinted with such negative experiences, that similar attacks in the future may be avoided.

The added protection is body-area specific as well. For example, a mountain lion tends to attack the neck of a victim and would grab a pet dog by the neck, thus rupturing the mace canister on the collar and releasing the chemical agent on the neck. This is the exact area that the lion attacked, and would attempt to re-attack. Even partially blinded, a lion would be forced to continue being subjected to the chemical irritant, because the victim is somewhat coated with the chemicals in the area being attacked.

For ranchers; although there is a distinct possibility that the rupture of the bladder bag within this device may not guarantee the survival of the animal wearing it, the extreme pain and discomfort brought upon the attacking animal after the device is ruptured may cause that predator to cease such actions on that herd in the future. That mountain lion may never visit that ranch again. In previous patents, a device would kill the predator at that location. That death has little effect in deterring fellow predators, and may even cause more to descend upon the area, due to the scent of the fresh predator's carcass.

Another positive aspect of this design is the potential for ranchers to attach this device to a bandage or other movement-limiting device, causing one specific animal in the herd to have limited ambulation, further causing that animal to be unable to flee. This would cause that animal to be the member of the herd targeted by a predator, thus greatly increasing the odds that the predator will come in contact with the animal with the passive chemical agent device.

The non-discriminating attachment aspect of this invention allows the passive chemical defensive device to be attached to any number of things, such as horse bridles, dog coats, house cat collars, children's scarves, and even knotted wool of sheep.

In a subdivision on the edge of open land that has been plagued by predatory theft of pets, a device like this could deter future attacks.

### BRIEF DESCRIPTION OF THE SEVERAL DRAWINGS

FIG. 1 is a perspective view of a primary embodiment of this delivery apparatus for use to deliver a self-defense debilitating substance according to one embodiment of the present invention, the internal bladder bag. Material will be rubberized or sealed non-porous material to hold the pressurized chemical irritant.

The defensive substance delivery pouch (A) illustrated in FIG. 1 is constructed by a single layer of rubberized latex or plastic, with fracture lines (E) capable of aiding fracture during an attack.

FIG. 2 is a perspective view of a primary embodiment of this delivery apparatus for use by the process of the present invention, the outer holder with a top clip. This material will be netting or porous fabric able to disseminate and dissipate the chemical irritant once punctured or squeezed. The outer bag will have a hook and loop or zippered access for removal.

Pouch (A) rests within the carrying case (B) made of porous material, which aids in dissipating agent once punctured. Case (B) is constructed of strong material such as cloth or netting, making fashionable colors easy to fabricate. Pouch (A) rests within the carrying case (B) via the zippered or hook & loop access port (D) shown as partially open I this view. Case (B) is attached to collars or clothing via hasp (C.) Hasp (C) is string or an open ended locking clip of any configuration. Hasps (C) can attach the case via the top or sides of the holder, or any other functional configuration.

FIG. 3 is a perspective view of a primary embodiment of this delivery apparatus for use by the process of the present invention, the outer holder with side clips for securing to a collar or clothing. The access port is again shown in the partially open position.

FIG. 4 is a perspective view of a primary embodiment of this delivery apparatus for use by the process of the present invention, the outer bag attached to a pet collar (F). The access port is again shown in the partially open position.

FIG. 5 is a perspective view of a primary embodiment of this delivery apparatus for use by the process of the present invention, the outer bag attached to a sleeve on a person's arm. The access port is again shown in the partially open position.

FIG. 6 is an exploded image view, including a cross-sectional view of the apparatus shown with the zippered slit partly opened. The access port is again shown in the partially open position.

Pouch (A) internal bladder bag containing the debilitating chemical (P.) The Outer Casing (B) and locking hasp (C.) The access port (D) shown partially open.

FIG. 7 is multi view, showing various designs of the device, and various attachments.

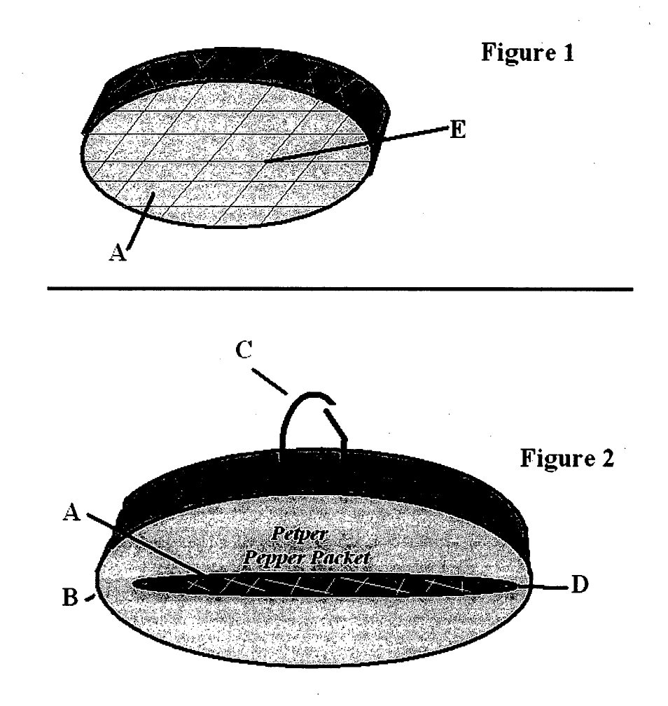

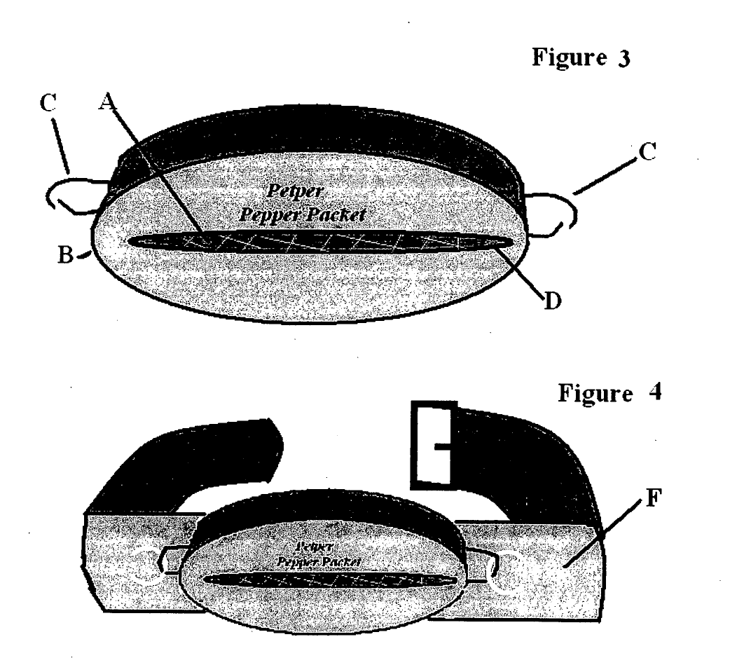

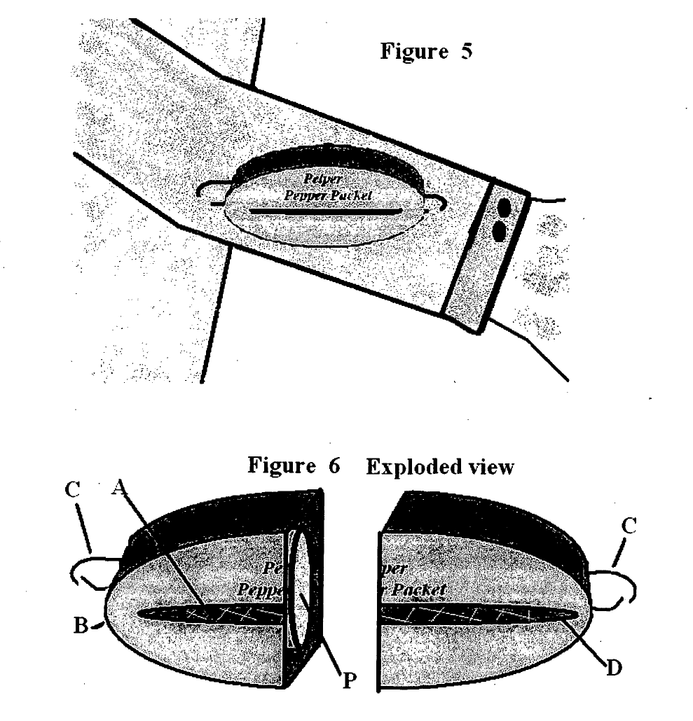

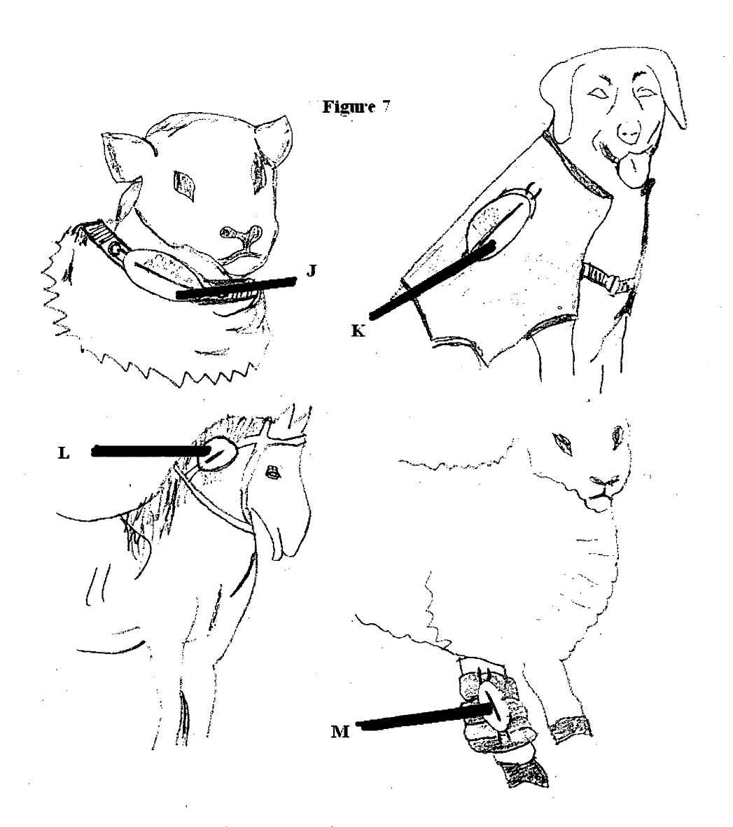

(J) shows attachment to knotted wool or collar of a sheep.

(K) shows attachment to the outside of a pet dog's coat.

(L) shows the attachment to a horse's bridle

(M) shows the attachment to a bandaged sheep's leg.

### DETAILED DESCRIPTION OF THE PREFERRED EMBODIMENT

The preferred embodiment of this defensive delivery apparatus is a pressurized and encapsulated chemical container, held in an outer casing of a fashionable netting or cloth material. When the capsule receives force from pressure or puncture of an attack, the chemical is released to deliver a debilitating substance. The internal bladder bag, once ruptured, allows the chemicals to dissipate in the immediate area, and will coat both the attacker and the victim. This system is completely passive and reactive. The inner bladder bag (canister) will only rupture with any applied direct force; such as the force received during an attack.

The outer bag, being of a porous material or netting, allows the ready dissipation of the chemicals, as well as providing a fashionable accent. The material preferred is of a colorful yarn, and allows many possibilities of patterns and color. The hasps used to attach the outer casing to the clothing or collar could be of nearly any design including safety pins, small locking carabiners, or pieces of material extending from the casing itself, to be used like tied straps.

The zippered or hook & loop access port allows access to the bladder bag, and facilitates the changing of spent or old canisters.

The debilitating substance used in the bladder bag may include any number of known compounds in a gel, creme, paste, liquid or any other like form. Some of the known debilitating substances include but are not limited to: pepper products or capsaicin; chloracetophenone or mace; orthochlorobenzalmalonitrile or tear gas; capsaicin or oleoresin capsicum also another term associated with pepper products. The substance could also be dyed a readily seen color, thus aiding ranchers from a distance when they survey the herd, to see if any pouches were activated.

In the foregoing description, those skilled in the art will readily appreciate that modifications may be made to the invention without departing from the concepts disclosed herein. Such modifications are to be considered as included in the previous claims.

I claim:

1. A non-pressurized or pressurized reactive pouch/canister held within a protective holder comprising:
(I) a core substance that is a non-lethal chemical irritant such as Oleoresin Capsicum (HOT CAYENNE PEPPERS—MACE).
(II) a removable bladder bag or canister containing the debilitating agent;
(III) an outer covering made of porous/netting material for decorative purposes and strength; and
(IV) a hasp(s) for hooking the outer case to a collar or item of clothing.

2. The invention of claim 1 further comprising scored lines to aid in fracture when bladder is bitten, clawed, squeezed or otherwise punctured.

3. The invention of claim 2 allowing the fashionable attachment of the encapsulated functional bladder to everyday attire utilizing a mesh or porous material case that is washable. This is similar in function to the netting used in smelling salts, but adds an element of fashion.

4. The invention of claim 3 wherein said hasp(s) is any hooking device(s) allowing the attachment of the whole invention to a pet's collar, pet's clothing, or human clothing in an area of the body that would be highly likely to be the area of impact from an attack.

6. The invention of claim 1 wherein the removal of a spent bladder bag or canister could be replaced by a new bladder bag or canister by way of the hook & loop or zippered access port.
